(19) United States
(12) Patent Application Publication
(10) Pub. No.: US 2022/0198552 A1
(43) Pub. Date: Jun. 23, 2022

(54) METHOD FOR OPTIMIZING AN ELECTRONIC ORDERING SYSTEM

(71) Applicant: FOOTFACT.COM GMBH, Hamm (DE)

(72) Inventor: Faik Burnic, Hamm (DE)

(21) Appl. No.: 17/599,421

(22) PCT Filed: Mar. 19, 2020
(86) PCT No.: PCT/DE2020/100221

§ 371 Date: Sep. 28, 2021

(30) Foreign Application Priority Data
Apr. 4, 2019 (DE) 10 2019 002 468.0

(51) Int. Cl. G06Q 30/06

(52) U.S. Cl. CPC G06Q 30/0643; G06Q 30/0621

(57) ABSTRACT

A method for optimizing an electronic ordering system for clothing, comprising the steps: provision of a web shop, in which clothing is offered, on a web-shop server; provision of a user terminal comprising a client program for communication with the web shop; provision of an electronic communications network for connecting the client and the server; provision of an electronic selection system for the user selection of an item of clothing offered in the web shop, the item of clothing being selected according to a size specification; provision of the electronic ordering system for the server and the client, in order to initiate a binding sales order for the size-dependently selected item of clothing; the method being characterized in that the client program, prior to the selection by the user of an item of clothing offered in the web shop, requests at least one specific size value from the user and transmits said value to the web-shop server, and the web-shop server controls the electronic selection system according to the specific size value, such that in a search request, the user is offered exclusively items of clothing for selection that correspond to the transmitted size value.

The present invention relates to a method for optimizing an electronic ordering system for clothing comprising the steps: provision of a web shop, in which clothing is offered, on a web shop server; provision of a user terminal with a client program for communication with the web shop; provision of an electronic communications network for connecting the client and the server; provision of an electronic selection system for user selection of an item of clothing offered in the web shop, the item of clothing being selected according to a size specification; provision of the electronic ordering system for the server and the client, in order to initiate a binding sales order for the size-dependently selected item of clothing.

Such a method is not known from the prior art.

If, for example, a person wants to order or buy a pair of shoes online on a buyer portal, this person is asked to specify his shoe size when making his selection. For this purpose, the person falls back to his usual shoe size. His selection is therefore based on experience. In addition, the person trusts that a conversion table offered on the buyer portal for internationally used shoe size systems is correct. Such a conversion table may indicate, for example, the German shoe size 45 as the US shoe size 11.5 and/or as the British shoe size 10.5. This conversion is neither internationally standardized nor have manufacturers agreed on a uniform size specification system which reflects certain sizes, e.g., the lengths and widths of a foot, in a standardized shoe size. Therefore, only conditionally usable statements regarding the expected actual shoe size or fit can be derived from a customary conversion table for the purchase of shoes.

Consequently, due to the global production of shoes for international markets, the correct calculation and especially conversion of shoe sizes is not always guaranteed. This problem results in the shoes ordered on the basis of a person's usual shoe size not fitting the person and therefore being returned to the buyer portal. The returns made for this reason are considerable and generate not only costs but also more traffic, a higher environmental impact and possibly more waste. Often, returned items are not even returned to the manufacturer but are simply disposed of beforehand.

The object of the present invention, therefore, is to further develop a method for optimizing an electronic ordering system for items of clothing so that items of clothing that fit as closely as possible in size may be selected.

The object is achieved by the client program requesting at least one specific size value from the user before the selection of an item of clothing is offered on the web shop and then transmitting said value to the web shop server with the web shop server controlling the electronic selection system on the basis of the specific size value in such a way that, in the event of a search request, the user is exclusively offered items of clothing for selection that are adapted to the size value provided.

With the method according to the invention, it is possible to determine the exact size of a body part to be measured in a relatively simple manner which thereby significantly reduces the number of returns in the online retail business. A very large portion of returns of items of clothing are a result of non-fitting sizes. The simple, accurate measurement of a body part and the use of the exact sizes resulting from this measurement when searching for items of clothing in a buyer portal reduces the risk of items of clothing being selected that do not fit and have to be returned.

It is also an advantage of the present invention that the step of requesting a specific size value comprises an optical measurement of a body part. By means of an optical measurement, geometric variables can be detected over a certain distance, e.g., without a tape measure.

It is also an advantage of the present invention that the step of an optical measurement of a body part comprises the digitizing of the body part and the calculation of the specific size value of the body part using digital image data. Digital image data is particularly suitable for calculating body shapes.

Another advantage of the present invention is that the digitizing of the body part comprises a step of capturing a digital image of the specific body part with a digital camera and transmitting the digital data set of the digital image to a computing device. This way, a commercially available digital camera, for example, a camera of a mobile device such as a smartphone or a tablet can be used.

It is also an advantage of the present invention that, after the step of transmitting the digital data set corresponding to the digital image to a computing device, the specific size value is calculated from the digital data set in the computing device by using an algorithm. This makes it possible for the foot size to be reproduced by the specific size value in such a way that this value can replace the usual shoe size or replace said shoe size as the basis for the order.

Another advantage of the present invention is that the step of capturing a digital image of the specific body part comprises the capturing of a reference object having at least one known reference value. Each user owns a plurality of reference objects having at least one known reference value. This is due to the fact that many objects of daily use are standardized. Thus, basically all objects standardized with respect to their size are suitable for the present invention. When these are placed next to or under the body part to be captured by a digital camera and are captured together with the body part, the computing device can recognize the standardized object and calculate the size of the body part arranged next to the reference object by means of a mathematical algorithm on the basis of the at least one known reference value.

It is also an advantage that, when the at least one specific size value is requested, the user terminal is, by means of the client program, connected to a second server on which the at least one specific size value is stored. This makes it possible for the method to be used not only on a desktop but also on a mobile device, for example, as an app on a smartphone or a tablet.

With the present invention, it is possible to determine the specific size value of a body part with or without a reference object and to use said size value as the basis for an online order. If a reference object is used, said reference object can be configured as desired.

In addition, the present invention can provide a digital archive in which items of clothing and their metric sizes are archived, and a synchronization is performed between the size determined by a user of his body part and a search request of the user on a buyer portal on the basis of the metric sizes of the item of clothing searched for that are stored in the archive. This avoids deviations of the actual metric size of an item of clothing from the reported clothing size which lead to wrong decisions and the associated returns.

One embodiment of the present invention is described in more detail below on the basis of the drawing.

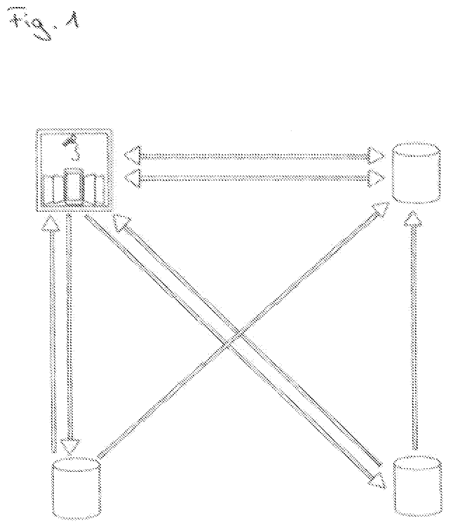

FIG. 1 is a schematic flowchart of a desktop version of the present invention;

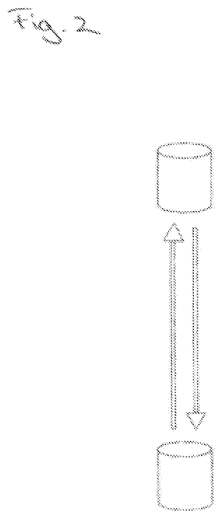

FIG. 2 is a schematic flow diagram of a mobile version of the present invention;

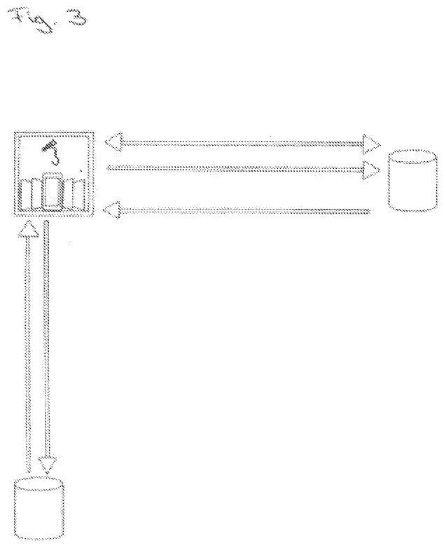

FIG. 3 a schematic flowchart of a version as a mobile seamless integration and

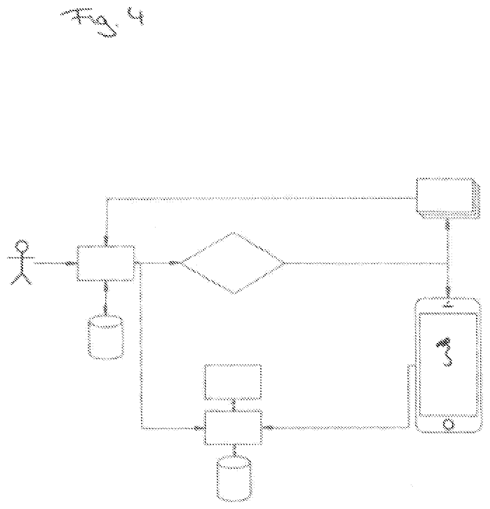

FIG. 4 is a schematic representation of a hardware solution for the generation of a specific value.

FIG. 1 is a schematic flowchart of a desktop version, FIG. 2 shows a mobile version and FIG. 3 is a mobile seamless integration version. They are provided to describe the method of the present invention by way of example. The method according to the invention is also explained by using the example of a shoe order but is not limited to the ordering of shoes. The method according to the invention may also be used to order other items of clothing or entirely different size-related items.

The customer selects a shoe and wants to determine the correct shoe size (1). For this purpose, an app, which has been installed on a user terminal beforehand, is available to the customer or the customer is taken to the app from the web shop/customer portal (2). In the web shop/customer portal, the customer is provided with a barcode, QR code or any other scannable character code that the customer scans with his user terminal (3). In order to uniquely identify the session (the current order process) a token is requested by means of the barcode or any other code (4). A backend system creates the token based on the barcode data (5). The customer then takes a photo of the relevant body part, in this case the foot, with the user terminal or the digital camera built into said device. The app is used to determine the length and the width of the foot (6). The digital image data for the photo (digital image), i.e., a specific size value composed from the length and the width as well as the digital data for the selected shoe model, are transmitted to the backend system (7). The backend system determines the correct shoe size based on the transmitted data or matches the specific size value composed from the length and the width with the shoe sizes of the shoe model in a database of the backend system (8). The backend system then transmits the appropriate shoe size to the app (9). The app displays the correct shoe size for the selected shoe model (10). The customer is redirected back to the web shop and the matching shoe size is displayed in the web shop (11).

FIG. 3 schematically illustrates an exemplary system that may be used in the method according to the invention. In the preferred embodiment, a web application 1, which is downloaded by the user 3 of a smartphone 5, is provided. With the help of this web application 1, the user 3 can take a photo of his foot, for example, with a digital camera 7 integrated on the smartphone 5. The system according to the invention comprises a reference object 9, which is preferably a standardized object, such as a coin, a credit card, a sheet of paper (e.g., DINA4, US letter size) or the like. Before taking a picture of, for example, the foot with the digital camera 7 integrated in the smartphone 5, the user 1 places the standardized object as a reference object 9 next to or under his foot so that both the reference object 9 as a whole and the foot can be seen in the search field of the camera 7 or the lens of the camera 7 (not shown). Then, the user 3 presses a shutter release button 11 and takes a picture of the foot and the reference object 9 lying fully next to or under the foot. Once captured, the image in the search field of the camera 5 becomes a digital data set which is transmitted to a computing device 15 by a digital data transmission device 13. This device calculates the size and optionally also the volume of the body part from at least some of the digital data of the digital data set. The system also comprises an electronic display device 17 for displaying the body part and optionally also the size of the body part that was captured and the body size that was determined.

The transmission device 13 comprises the web application 1 that is present in an app memory 19. This application is programmed in such a way that a plurality of reference objects 9 with at least one known reference value can be stored. When the 2D image of the foot is taken together with the reference object 9 selected by the user 3, the web application 1 recognizes the captured reference object 9 from the plurality of reference objects 9 and its at least one reference value. The web application 1 also comprises an algorithm by means of which a calculation of the foot that is also detected in the 2D image can be calculated from the at least one reference value of the reference object detected in the 2D image. For this purpose, the 2D images (pictures) are electronically converted into 3D diagrams. Such a conversion can be performed by commercially available image processing programs. The computing device 15, which is integrated in the web application 1 or which is at an external location, then calculates the exact dimensions of the length, width and volume of the foot or any other body part. For this purpose, the computing device 15 also comprises skin recognition software. This software is currently used in social media, for example, to detect illicit nudity in photographs. Such software may be based, for example, on a few phyton scripts, programming libraries such as Open CV or the OCR software Tesseract. Software developed for the present invention can recognize body parts on the basis of skin outlines and, if necessary, delimit and display them on the display device 17. As the body part to be captured by the camera 7 moves, the perspective changes and so does the course of the line. The size and volume of the body part can also be determined mathematically from the contour determined in this way so that a reference object 9 can be dispensed with altogether.

In other embodiments, any other body part and even any other object can be measured in this manner.

Independently of the web application 1 and the smartphone 5, a database 21 (digital archive) is created in the computing device 15 itself or in a computer network connected to the computing device 15 in which an unlimited number of items of clothing, for example, shoes, gloves, headwear, outerwear and underwear, are recorded. Commercially sold clothing is marked with a standard but periodically changing size specification. Such a size specification also varies from one distribution country to the next and from one production country to the next. Thus, a buyer cannot be certain that an item of clothing of a particular designated clothing size from a first manufacturer is actually the same size as the same item of clothing with the same designated clothing size from a second manufacturer. The database 21 now archives items of clothing that are assigned actual clothing sizes, metric or non-metric, in addition to the designated clothing sizes, regardless of the manufacturer.

Thus, two identical items of clothing with the same designated clothing size may have different metric or non-metric sizes and/or, conversely, two identical items of clothing with different designated clothing sizes may have identical metric or non-metric sizes.

The method according to the invention using the system according to the invention comprises a synchronization of the size of a body part measured by the system with the electronic search request in a buyer portal 23 (Internet). Thus, when the user 3 makes an electronic search request in the buyer portal 23 for an item of clothing with a certain clothing size, the search request comprises the actual measured size of the body part of the user 3 (searcher), and an electronic search engine in the computer network (e.g., the Internet) matches the search request with the actual metric or non-metric size of the requested item of clothing stored in the archive of the database 21 (synchronization). The user 3 then receives, on the basis of his search request, a results list with items of clothing which may have different clothing sizes but which actually fit the actual measured size of the body part.

The system according to the invention also comprises a memory 25 in which the respective actual measured size of the body part in question is stored so that the user 3 no longer has to perform an optical measurement of this body part for each purchase transaction on the Internet or another computer network. The system according to the invention can then always refer to the relevant actual measured body size of the body part in question in the memory 25 in order to perform the synchronization with the search request.

The technical processes that run in the background are generally known and are not an object of the present invention. In technical terms, the prerequisite for the present invention is the simple and fast detection of the actual size of a body part and the synchronization of digital data of the measured body part size with the metric sizes of the items of clothing stored in the digital archive, irrespective of their clothing size specifications.

Within the meaning of the invention, the term “metric sizes” is understood as a generic term customary in a civilization for all measurement sizes with which comparable absolute measurement values can be expressed. In civilizations where no metric systems are used (e.g., USA, GB), these measurements are to be replaced within the meaning of the invention by the non-metric system customary values.

### LIST OF REFERENCE SIGNS

1 Web application
3 User
5 Smartphone
7 Camera
9 Reference object
11 Shutter release button
13 Transmission device
15 Computing device
17 Display device
19 App memory
21 Database
23 Buyer portal
25 Memory

Labeling of the Original FIG. 1:

FootFact App:
Calculate the foot measurements via the smartphone photo
Comparison of foot sizes with backend
Display of the correct shoe size in the web shop
Storage of the foot measurements in the backend for later, further use, e.g., shoe size statistics
Customer finds a shoe in the web shop
Is uncertain because of the size
For first time use: Download FootFact app
If FootFact app available—take picture
Adoption of the correct foot size in the app
Acceptance of the correct shoe size in the web shop
Complete the purchase—done!

Web Shop:
E.g., Zalando, 21run, Mirapodo
Comparison with backend manufacturer data
Must be able to access data from all manufacturers offered in the shop
Connection/PlugIn
PHP
Javascript
SLA's Service Level Agreement
Customer support 24/7

Backend
Migration
Hosting
Monitoring
Data administration
Data storage of shoe measurements
Data storage of measured foot dimensions
Automation
Access to manufacturer data but not directly, only via the app
Inner shoe dimensions
Customer finds a shoe in the web shop
Is uncertain because of the size
For first time use: Download FootFact app
If FootFact app available—take picture
Adoption of the correct foot size in the app
Acceptance of the correct shoe size in the web shop
Complete the purchase—done!
Automatic integration of the inner shoe dimensions per template
Interface/API to the shoe manufacturer
Manufacturer data must be available externally to web shops (see web shop/Zalando/Otto etc.)
SLA's

Web Shop Versus Shoe Manufacturers
E.g., Adidas, Asics, GEOX, Skechers, Birkenstock
Connection/PlugIn
Integration of inner shoe dimensions, later volume
PHP
Javascript
SLA's Service Level Agreements
Customer support 24/7

Labeling of the Original FIG. 2:
Web shop, e.g., nike.com
1.—Select shoes
2.—Open FootFact functionality
3.—Determine shoe size
4.—Transmission (length, width, shoe model)
   FootFact Server
5.—Compare foot size with shoe size
6.—Redirection to the web shop with the matching shoe size

Labeling of the Original FIG. 3:
Web shop, e.g., nike.com
1.—Select shoes
   Determine shoe size
   FootFact App
3.—Scan barcode
6.—Determine foot size (length and width)
10.—Display the correct shoe size

FootFact Server
5.—Create token
8.—Match the foot size and the shoe size
2.—Forward to the app
11.—Return to the web shop with the correct shoe size
4.—Request token
7.—Transmission (length, width, shoe model)
9.—Transmission (correct shoe size)

1. Method for optimizing an electronic ordering system for clothing, comprising the steps:
Provision of a web shop, in which clothing is offered, on a web shop server;
Provision of a user terminal comprising a client program for communication with the web shop;
Provision of an electronic communications network for connecting the client and the server;
Provision of an electronic selection system for the user selection of an item of clothing offered in the web shop, the item of clothing being selected according to a size specification,
Provision of the electronic ordering system for the server and the client, in order to initiate a binding sales order for the size-dependently selected item of clothing;
characterized in that the client program, prior to the selection of an item of clothing offered in the web shop by the user, requests at least one specific size value from the user and transmits said value to the web shop server, and the web shop server controls the electronic selection system according to the specific size value such that, in a search request, the user is offered exclusively items of clothing for selection that correspond to the transmitted size value.

2. Method according to claim 1, characterized in that the step of requesting a specific size value comprises an optical measurement of a body part.

3. Method according to claim 2, characterized in that the step of optically measuring a body part comprises the digitizing of the body part and the calculation of the specific size value of the body part from digital image data.

4. Method according to claim 3, characterized in that the digitizing of the body part comprises a step of capturing a digital image of the specific body part with a digital camera and transmitting the digital data set underlying the digital image to a computing device.

5. Method according to claim 4, characterized in that after the step of transmitting the digital data set corresponding to the digital image to a computing device, the specific size value is calculated from the digital data set in the computing device by using an algorithm.

6. Method according to claim 5, characterized in that the step of taking a digital picture of the specific body part comprises the capture of a reference object having at least one known reference value.

7. Method according to claim 6, characterized in that when at least one specific size value is requested, the user terminal is connected, by means of the client program, to a backend server on which the at least one specific size value is stored.

8. Method according to claim 7, characterized in that a token is created in the backend server to uniquely identify an operation.

9. Method according to claim 8, characterized in that in the backend server, the specific size value is matched with a clothing size, and the clothing size matching the specific size value is determined.

10. Method according to claim 9, wherein the backend server transmits the matching clothing size to the app and/or to the web shop.

11. Method according to claim 10, characterized in that the specific size value is displayed on a display device.

12. Method according to claim 5, characterized in that the step of taking a digital picture of the specific body part comprises the capture of a reference object having at least one known reference value.

13. Method according to claim 12, characterized in that when at least one specific size value is requested, the user terminal is connected, by means of the client program, to a backend server on which the at least one specific size value is stored.

14. Method according to claim 13, characterized in that a token is created in the backend server to uniquely identify an operation.

15. Method according to claim 14, characterized in that in the backend server, the specific size value is matched with a clothing size, and the clothing size matching the specific size value is determined.

16. Method according to claim 15, wherein the backend server transmits the matching clothing size to the app and/or to the web shop.

17. Method according to claim 16, characterized in that the specific size value is displayed on a display device.

18. Method according to claim 1, characterized in that when at least one specific size value is requested, the user terminal is connected, by means of the client program, to a backend server on which the at least one specific size value is stored.

19. Method according to claim 18, characterized in that the specific size value is displayed on a display device.

20. Method according to claim 1, characterized in that the specific size value is displayed on a display device.
